(19) United States
(12) Patent Application Publication
(10) Pub. No.: US 2006/0186569 A1
(43) Pub. Date: Aug. 24, 2006

(54) Moldable multi-component composite

(76) Inventors: Daniel R. Olive, Cincinnati, OH (US); Glenn R. Sprague, Brighton, MI (US); Robert W. Steinkraus, Westland, MI (US)

Correspondence Address: WOOD, HERRON & EVANS, LLP, 2700 CAREW TOWER, 441 VINE STREET, CINCINNATI, OH, 45202, US

(21) Appl. No.: 11/359,345

(22) Filed: Feb. 22, 2006

Related U.S. Application Data
(60) Provisional application No. 60/655,210, filed on Feb. 22, 2005.

(51) Int. Cl. B27N 3/00

(52) U.S. Cl. 264/109

(57) ABSTRACT

A multi-composite material comprised of core filler particles encapsulated by a bonding agent. The overall composite generally includes a composite mat and bonding agent which encompasses the core composite for an integral bond and which may be finished to a Class A automotive finish. The multi-composite material is typically used for structural panels, vehicle bumpers, and like applications.

### CLAIM OF PRIORITY

This application claims priority to U.S. Provisional Patent Application Ser. No. 60/655,210 and hereby incorporates by reference that application in its entirety.

### FIELD OF THE INVENTION

The present invention relates to composite materials in general and more specifically to composite materials for use in structural panels and like applications.

### BACKGROUND OF THE INVENTION

It is common to create structural panels by layering various compatible materials and securing one layer to another by means of bonding techniques. This is typically done to take advantage of the unique properties of each layer, such that the entire structure will have more desirable overall physical properties than any of the individual material layers within the structure. However, layered composites are generally limited to flat panel shapes, with limited depth of facial contours, and must be comprised of compatible materials that will bond to one another surface-to-surface. Another limitation of layered composite panels is the uniformity of each layer, preventing the implementation of varying regional physical properties. Given the inherent incompatibility and tendency toward subsequent delamination of thermoplastics and certain thermoset bonding agents, the joining of these two materials has historically been considered an unacceptable approach to developing a layered composite material.

It is also common to blend compatible materials to create layered composites that exhibit unique mechanical properties. Compatible material combinations such as fiberglass reinforced thermoset resins and carbon fiber reinforced thermoset resins are used particularly (but not exclusively) in the aerospace and ground transportation industries to establish high strength-to-weight ratios. While well suited to exterior “skin” and “shell” geometries, the benefits associated with these materials diminish when the structure needs to be a fully three-dimensional shape (i.e., a flat six-sided box), with good appearance on both faces and the edges. It is common to fill voids in shell or hollow geometries to achieve “three-dimensional” shapes by introducing expandable materials such as polyurethane or by adding materials like pieces of cut balsa wood. However, the expandable urethane method causes the shell portion(s) to be exposed to significant and potentially deforming expansion pressure during the cure process. Additionally, both the expandable urethane method and the balsa wood fill technique are expensive.

It is also common to transfer a resin, under significant pressure, into a closed mold containing compatible stiffening materials to create a composite. This approach requires a mold of sufficient stiffness and durability to withstand the associated resin injection pressure, and filler materials like balsa wood, which can withstand the pressure are expensive. Also, it can be difficult to maintain the position of structural inserts when they are subjected to resin injection loads.

### OBJECTS OF THE INVENTION

It is the object of the present invention to provide a unique solution to the aforementioned product and process issues.

### SUMMARY OF THE INVENTION

The uniqueness of this invention is the ability to integrate composites of varying mechanical properties to allow for regional structural behavior, thus meeting multiple product performance demands and particularly to provide an internal core material that provides a strong bonded transition zone connecting the two external faces of the panel together. This feature provides for the controlled transfer of mechanical loads from one face through the transition zone to another face, increasing the resistance of the overall component to flexural, compression, and column loads.

The process starts out as two open molds, into which a variety of composites can be inserted, singularly or in plurality. As the contents of each open mold start to cure, the core material is cast into one or both sides, with the two open molds then articulating to become a single closed mold, with the aforementioned core material sandwiched between the mold halves.

When using a very lightweight thermoplastic material and a thermoset polymer binder, a composite material is created not by bonding these two incompatible materials, but by mixing them together. Thermoplastic particles or expanded beads are blended with the thermoset liquid, whereby the thermoset material completely coats the individual thermoplastic particles. The thermoset material then cross-links or bonds to itself and after it hardens, the thermoplastic particles are captured within the resulting three-dimensional matrix of thermoset material.

The present invention has many advantages over current solid or composite panels. First, because the fill and bonding/binding agent mixture is a fluid prior to the cross-linking process, the mixture can be poured into a mold and cast at room temperature, either through the use of two open molds being compressed into a closed mold configuration or by pouring or allowing the mixture to flow into a closed mold cast. Of import, the mold or cast can be detailed, providing for facial and peripheral features of significant depth and precision.

Another advantage of the present invention is that there is no measurable shrink or warp associated with the cross-linking or hardening process, resulting in excellent dimensional control for the final product. Additionally, there is no measurable expansion associated with the cross-linking process, reducing the amount of stiffness required for the mold. Additionally, the room temperature casting of the self-curing thermoset requires no external heat source for processing. In other words, it is a very energy efficient and cost efficient process.

In addition to the load bearing and strength properties of the composite material adding to its overall safety, the final product exhibits a low tendency toward flammability as the thermoplastic material, if that is the filler material used, is fully encapsulated within the thermoset material matrix. Also, thermal conductivity of the composite product can be very low, or can be very high depending on the fill material used. These extreme conditions can be exhibited in different regions within the same component.

Another advantage is that prior to molding or casting the thermoplastic/thermoset core composite in its fluid mode, the mold cavity surfaces can be lined with additional materials to further enhance strength, stiffness, and resistance to penetration by foreign fluids or solid objects into the final product. Also, since this is a room temperature casting process, it is feasible to bury within the cast core portion of the product a wide variety of additional filler materials to enhance the performance of the final product and to support localized loads.

Furthermore, using a mixture of a light weight filler (e.g., expanded thermoplastic beads) and thermoset resin, the result is an extremely light material with structure and mechanical properties suitable for joining the two faces economically, yielding a high strength-to-weight ratio. Conversely, when a low cost, but heavy filler (e.g., pea gravel) is mixed with a thermoset resin, the ability to join the two faces is still economical, but with a dramatically different resulting weight. The invention allows for the possibility of combining these two radically different core materials regionally into one product (e.g., ballast for specific product orientation). Also, use of the inexpensive (coated) core material minimizes the proportional content of the more expensive (coating) thermoset material.

Finally, the finished part bonds well with external components and can be painted to a Class-A automotive finish.

The above and other objects and advantages of the present invention shall be made apparent from the accompanying drawings and the brief description thereof.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a cross-sectional view of a first embodiment of the composite material of the present invention.

FIG. 1A is a detail view of a portion of the composite material shown in FIG. 1.

FIG. 1B is a detail view of a portion of the composite material shown in FIG. 1A.

FIG. 2 is a cross-sectional view of a second embodiment of the composite material of the present invention.

FIG. 3 is a flow chart showing a process of making the composite material of the present invention.

FIG. 4 is a perspective view of the composite material of the present invention being used for an engine access door (EAD) for a bus.

### DETAILED DESCRIPTION OF THE INVENTION

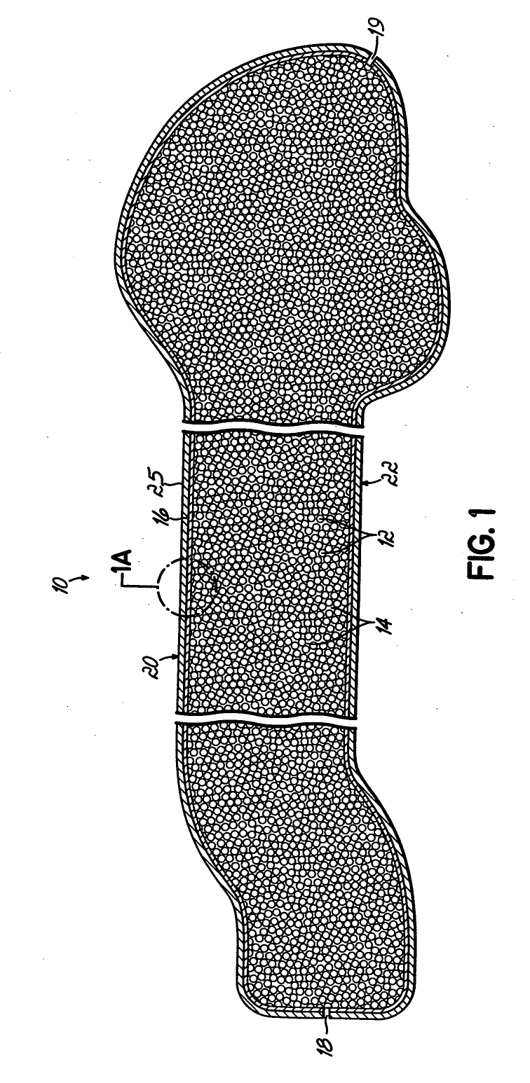

Referring to the Figures, particularly FIG. 1, the moldable composite material 10 of the present invention is comprised of a core composite having a plurality of filler particles 12 which are coated and encapsulated by a bonding agent 14. The filler particles 12 are typically polymer-based (expanded or not expanded). In a preferred embodiment, the filler particles 12 are comprised of expanded thermoplastic (e.g., polystyrene) beads, however, other types of filler particles can also be used. For example, the filler particles 12 can be rubber-based (e.g., ground rubber from used tires), metal-based (e.g., aluminum needles), naturally occurring terrestrial materials (e.g., pea gravel), or even organic based materials (e.g., ground up peanut shells or corn cobs). The type of material used for the filler particles 12 typically will vary depending on the desired application for the finished composite product. Hence, if the desired characteristic of the final product is a lightweight composite, lighter weight fill particles 12 would typically be used. Alternatively, if it is desirous to have a heavier weight product or a metallic-based product, the appropriate filler particles 12 to achieve those objectives would be used.

Additionally, different types of particles 12 could be used in the same composite. In some applications, it may be desirous to homogeneously blend different particles together, but in other applications, it may be advantageous to use different particles in different regions in the finished product. For example, it may be desirous to have a product that is weighted or biased in a particular direction. Such biasing can be accomplished by mixing heavier weight filler particles 12 in the region of the composite product that is desirous to be weighted. It may also be desirous to use different fill 12 in different regions based on the thermal conductivity of the particles. For example, it may be desirous for certain areas on a particular product to more rapidly dissipate heat.

Moreover, different filler materials may be used at different points where the composite product will be attached to other components. For example, it might be desirous to have metallic or magnetic fill material used at locations where a sign, bumper, sticker, name plate, etc. might be attached to a panel or bumper. It might also be desirous to have special fill material at the locations where a hinge, hydraulic bar, or signage might be attached to a door panel so as to provide additional localized strength or reinforcement. Additionally, nonparticulate materials could also be inserted in the fill 12 and bonding agent 14 mixture at these locations to provide additional reinforcing. For example, a reinforcing bracket, plate, or rod could be positioned in the fill particulate 12 at the location where a hinge will attach to a door panel to provide for additional reinforcing. Also, wiring harnesses, tubing, heating and/or cooling ducts, or like components could be buried within the composite product.

Additionally, different filler materials may be used in different applications to achieve different overall flexibleness. The flexibleness of the composite product can also be adjusted by varying the type of bonding agent 14 that is used. Some bonding resins, when cured, will be more flexible than others. Hence, the flexibility of a composite product can be adjusted by varying the filler material, the bonding agent, or both.

The use of different filler materials and/or bonding agents can also be applied within the same application to achieve different zones of flexibility. For example, it may desirous to have the exterior side of a composite panel of a bus to be firm and rigid and the interior side, which passengers contact, to be softer. Similarly, it may be desirous to have doors edges, corners, or the exterior portion of a bumper to have some give while the interior portion of these components to be more rigid.

Moreover, the particulate fill 12 and bonding agent 14 could also surround a displacement bladder which could be used to insert a fluid or other item into the composite product. For example, it may be advantageous to transport a particular composite product in a light weight hollow configuration, but then fill it with sand or water to provide for extra strength, insulation, or energy absorption prior to. operation. Such a displacement bladder could be comprised of commercially available mylar balloons or other like expandable materials. The use of a displacement bladder can also be useful in the molding or casting of composite products.

The bonding agent 14 is typically a thermoset polymer binder such as, but not necessarily exclusively, epoxy. When the plastic particles are used as the filler 12, the bonding agent 14 does not actually bond the thermoplastic particles to each other, but rather coats and encapsulates the particles as the epoxy cures and adheres to itself. Preferably an epoxy or urethane will be used, but any like resin, glue, or adhesive can be used as the bonding agent.

As shown in FIG. 1B, the composite material's core matrix is internally self-venting, suggesting that it may have good-to-excellent crush properties. Not only will the expanded beds crush upon impact locally, but also the entire structure should absorb energy by way of the entrapped air passing laterally through the self-venting, interconnected porous structure. As long as the exterior skin surfaces are non-porous or minimally porous, the areas adjacent to the impacted portion of the structure will accept pressurized air from the impacted location. This feature may be particularly valuable for structures like the side wall of a transit bus or a vehicle bumper.

The composite material's core matrix also can act as a filter. As shown in FIG. 1B, there are typically interconnected spaces or pockets following a nonplanar torturous path 13 throughout the core matrix. By varying the size of the filler material, either in different applications or within the same application, various filtration rates and properties can be achieved. Additionally, if the bonding agent was applied so as to not completely encapsulate the filler material, the filler material itself could contribute to the filtration process. Similarly, if it was desirous to not have any filler material in a particular composite product, a plaster or like filler material could be partially encapsulated by the bonding agent and then this material could be washed or flushed out of the matrix after it has cured, leaving a hardened matrix with a plurality of passageways throughout.

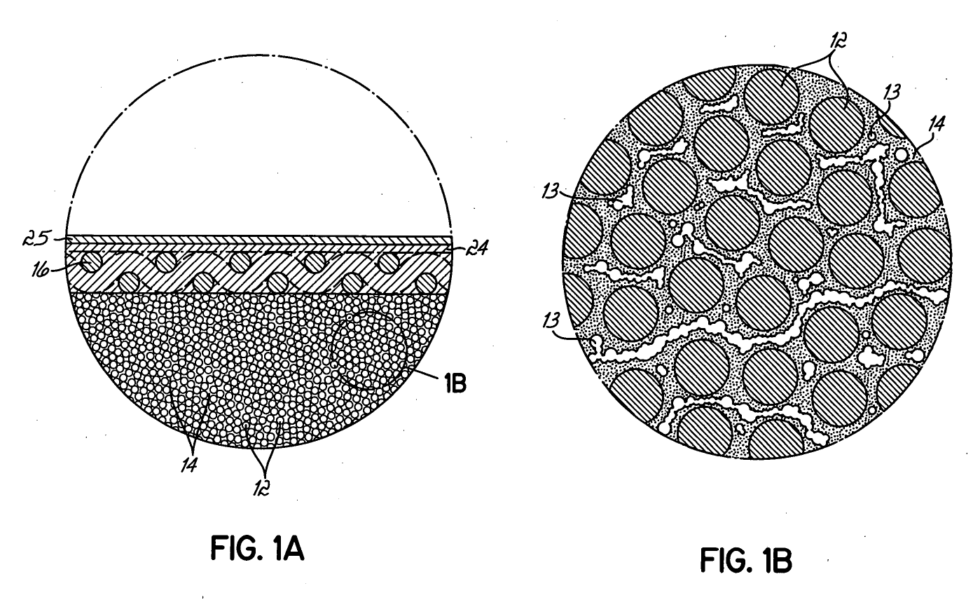

As shown in FIGS. 1, 1A, and 2, a mat 16 typically surrounds the bonding agent and filler mixture. In a preferred embodiment, a glass fabric or mat is used. However, other exterior mats such as a carbon fiber fabric, cloth fabric, chopper gun fiberglass, or like materials can be used. In some applications, it may be desirable to use one type of mat for an exterior surface, e.g., a glass mat that can be finished, and a cheaper or lower weight mat for an interior surface that will not be exposed the same factors (e.g., aesthetics, impact from foreign objects).

Typically, as shown in FIG. 1, the mat 16. will surround the entire composite product and can have a mold parting line 18, 19 located at any point along the exterior circumference of the product. In other words, the mold parting line 18 may be located generally at the half way point between the upper surface 20 and the lower surface 22 of the composite product 10 or it may be located at a position, as illustrated by mold parting line 19, near the bottom of the composite material. In other words, the mold parting line may be located midway between the upper and lower faces 20 and 22 or be positioned anywhere else along the periphery of the composite product.

Also, in a preferred embodiment, the exterior mat 16 will wrap around the sides and thus provide added strength and support to the composite product 10. However, as shown in FIG. 2, it is not essential that all the edges necessarily be wrapped. For example, in some applications, only an exterior face may be desirous of having a non-porous surface that can be finished to a Class A automotive paint finish whereas the ends or even the rear side may be left without a wrap, i.e., in an unfinished state.

Preferably, the blended core material, comprised of the particulate fill particles 12 and the bonding agent 14 will also bond to the exterior mat 16. In other words, the interior core material is not simply filling a cavity defined by the mat(s), but upon curing, is actually bonded integrally with the mat(s). The ability of the facial material used for the outer faces to molecularly bond to the core material blend provides for the transfer of mechanical loads from one face to the other.

Typically, a bonding agent 24 will coat the exterior surface of the composite product 10. This bonding agent may be the same bonding agent that is used to encapsulate the filler particles 12, or it may be a different bonding agent. In a preferred embodiment, this bonding agent is also an epoxy that may be finished or painted to a Class A. automotive paint finish. Typically, the bonding agent 24 will first be applied to the surface of the casting mold. This allows for an external surface that can be painted or otherwise finished. The mat 16 is then applied over the bonding agent. The bonding agent then permeates the mat 16. Additional bonding agent may also be applied over the mat 16 after it is inserted into the casting mold.

Alternatively, a mat 16 that has been pre-impregnated with a bonding agent could be placed over a first layer of bonding agent or directly on the casting mold. In either case, as shown in FIG. 1A, the mat 16 will be permeated and encapsulated by the bonding agent 24. The particulate fill 12 and bonding agent 14 (which may be identical to the bonding agent 24) mixture is then inserted into the casting mold.

In an alternative embodiment, a finishing layer of a bonding agent 25 may first be applied to the surface of the casting mold. This layer, as shown in FIG. 1A, will be the external layer, and will be the final surface that can be painted to a Class A automotive finish. This bonding agent, may or may not be identical to the second bonding agent 24 layer which will be applied over the first layer.

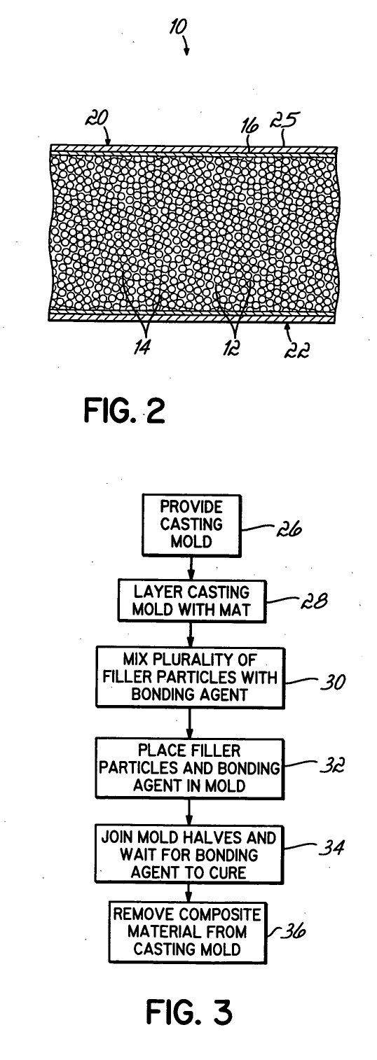

As is clear from FIG. 1, the composite material of the present invention is not required to be formed in layers and it is not restricted to flat panels. Composite materials may be formed with curves to conform to the design requirements of the desired product. FIG. 3 illustrates one process of forming or molding the composite material. As shown in FIG. 3, the first step is to provide a casting mold (Block 26). If a mat will be used, it is then placed in the casting mold (Block 28). As discussed, in alternative embodiments, partial or no mats may be used. Typically, the glass mat will extend over the entire surface of the mold and adapt or form to the shape of the casting mold. The transition zone particles and bonding agent are preferably pre-mixed (Block 30) and then applied to the mold or applied on top of the mat in a blended or mixed form (Block 32). Alternatively, filler particles may be inserted into the mold and then mixed with the liquid bonding agent. In either case, the two halves of the mold are then joined together and compressed to allow the filler particles and the bonding agent to form into the shape of the mold and cure (Block 34). This is a cold molding process, in that no external heat is necessary to create the initial composite product. Once the bonding agent has hardened, the composite product is removed from the mold (Block 36).

Additionally, while two casting mold halves may typically be used, the resin/filler blend could also be gravity poured or pumped (i.e., at low pressure) into the molds after they have been mated into a closed mold configuration.

Also, while not shown, a displacement bladder could be used to form a product with a hollow core. The use of a bladder could also be advantageous in displacing the filler and binding agent mixture to the outer portions of the mold, thus minimizing the amount of filler and binding agent needed to fill out a particular mold.

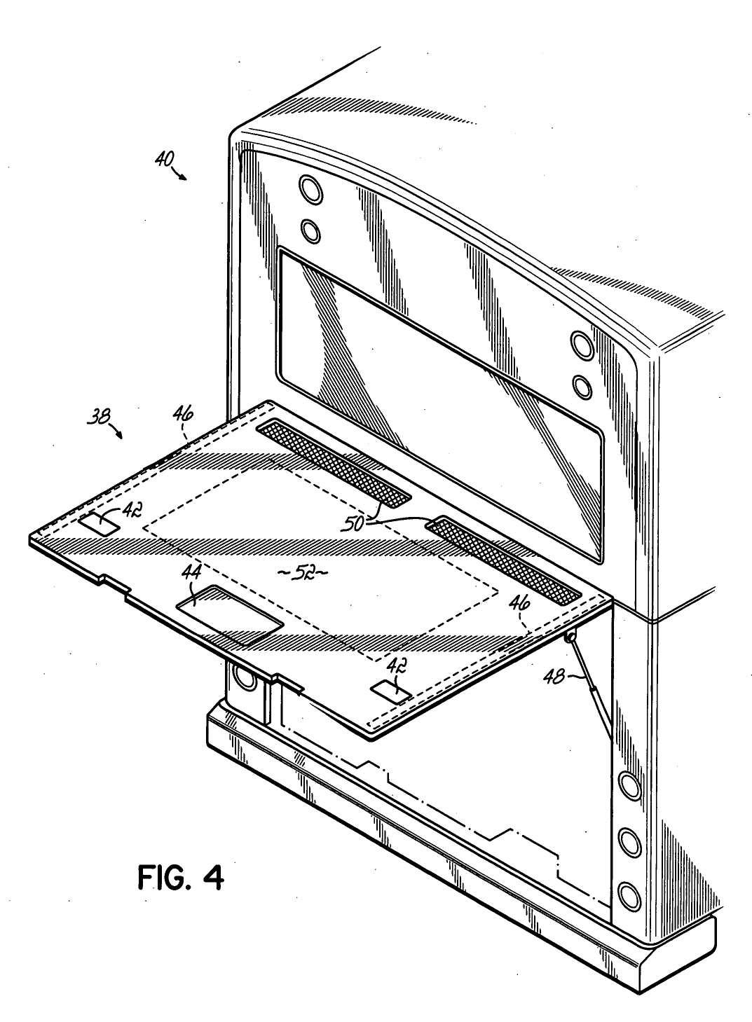

FIG. 4 shows an engine access door (EAD) 38 of a bus 40 which is an example of a product that can be formed using the composite material of the present invention. Various cavities, apertures, and indentations 42, 44 can be molded into such a final composite product. Additionally, as discussed, a reinforcing bracket, plate, rod, or like component could be strategically positioned within the particulate fill 46 to facilitate the attachment of a door brace, lever, hinge, or lift device 48. Also, special thermal fill or even vents 50 may be strategically positioned at locations to facilitate the dissipation at heat. Still other zones 52 within the composite may have materials, particulate or nonparticulate, to facilitate the attachment of signage or other components.

While the present invention has been illustrated by description of various embodiments and while these embodiments have been described in considerable detail, it is not the intention of the applicant to restrict or in any way limit the scope of the claims to such detail. Additional advantages and modifications will readily appear to those skilled in the art. The invention in its broader aspect is, therefore, not limited to the specific details, representative system, apparatus, and method, and illustrative example shown and described. Accordingly, departures may be made from such details without departing from the spirit or scope of the applicant's general inventive concept.

What is claimed is:

1. A moldable composite material formed in the shape of the casting mold comprising:
a plurality of filler particles;
a mat generally formed in the shape of the casting mold encompassing the totality of the plurality of filler particles; and
a bonding agent fixedly securing the plurality of filler particles in the general shape of the casting mold and fixedly attaching the mat to the particles, the bonding agent also providing an automotive grade paintable coat on the exterior surface of the mat.

2. The moldable composite material of claim 1 wherein the plurality of filler particles are thermoplastic beads, polystyrene beads, rubber particles, magnetic particles, metallic particles, aluminum needles, terrestrial particles, pea gravel, organic particles, peanut shells, or corn cobs.

3. The moldable composite material of claim 1 wherein the plurality of filler particles are comprised of a plurality of different types of particles.

4. The moldable composite material of claim 1 wherein the plurality of filler particles are comprised of a plurality of different homogeneously blended types of particles.

5. The moldable composite material of claim 1 wherein the plurality of filler particles are comprised of a first set of particles and a second set of particles, the first set of particles being generally localized in one region of the composite material and the second set of particles being generally localized in a second region of the composite material.

6. The moldable composite material of claim 1 further comprising a nonparticulate reinforcer integral with the composite material.

7. The moldable composite material of claim 1 wherein the mat is a glass mat, carbon fiber fabric mat, cloth fabric mat, or a chopper gun fiberglass mat.

8. The moldable composite material of claim 1 wherein the bonding agent is an adhesive, glue, resin, epoxy, urethane, or thermoset polymer binder.

9. The moldable composite material of claim 1 wherein the bonding agent is comprised of a first type of bonding agent and a second type of bonding agent, the first type of bonding agent generally localized in one section of the composite material and the second type of bonding agent generally localized in a second section of the composite material.

10. The moldable composite material of claim 9 wherein the plurality of filler particles are comprised of a first set of particles and a second set of particles, the first set of particles and the first type of bonding agent generally in one section of the composite material and the second set of particles and the second type of bonding agent generally localized in a second section of the composite material.

11. A moldable composite material formed in the shape of the casting mold comprising:
a bonding agent matrix having a top side and a bottom side;
a plurality of filler particles fixedly positioned within the matrix; and
a mat generally formed in the shape of the casting mold, the mat being impregnated with a securing bonding agent, wherein the securing bonding agent fixedly attaches the mat to the top side and the bottom side of the bonding agent matrix.

12. The moldable composite material of claim 11 further comprises:
a finishing bonding agent fixedly attached to the securing bonding agent distally from the bonding agent matrix, the finishing bonding agent having an automotive grade paintable exterior surface distally positioned from the bonding agent matrix; and
an automotive grade paint coating secured to the automotive grade paintable exterior surface.

13. The moldable composite material of claim 12 wherein the bonding agent matrix further comprises a plurality of energy absorption air passages, wherein pressure exerted upon a first portion of the bonding agent matrix will transfer energy through the plurality of energy absorption air passages to another portion of the bonding agent matrix.

14. The moldable composite material of claim 13 wherein the plurality of filler particles are comprised of thermoplastic beads, polystyrene beads, rubber particles, magnetic particles, metallic particles, aluminum needles, terrestrial particles, pea gravel, organic particles, peanut shells, or corn cobs.

15. The moldable composite material of claim 14 wherein the plurality of filler particles are comprised of a first set of particles and a second set of particles, the first set of particles being generally localized in one region of the bonding agent matrix and the second set of particles being generally localized in a second region of the bonding agent matrix.

16. The moldable composite material of claim 15 wherein the bonding agent matrix encapsulates the filler particles.

17. The moldable composite material of claim 16 further comprising a nonparticulate reinforcer integral with the bonding agent matrix.

18. The moldable composite material of claim 17 wherein the bonding agent matrix further comprises a first portion that is flexible and a second portion that is rigid.

19. The moldable composite material of claim 11 wherein the bonding agent matrix further comprises a plurality of filtration passages, wherein a substance that transfers through the filtration passages from a first portion of the bonding agent matrix to a second portion of the bonding agent matrix will be filtered.

20. A method of making a moldable composite material comprising the steps of:
providing a casting mold;
inserting a mat into the mold;
mixing a plurality of filler particles with a bonding agent;
placing the filler particles and the bonding agent in the mold;
closing the mold and waiting for the bonding agent to cure; and
removing the composite material from the casting mold.
